(19) United States
(12) Patent Application Publication
(10) Pub. No.: US 2006/0273037 A1
(43) Pub. Date: Dec. 7, 2006

(54) Aquarium filter

(76) Inventor: Alberto J. Venezia, Boca Raton, FL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/146,733

(22) Filed: Jun. 7, 2005

(51) Int. Cl. A01K 63/04

(52) U.S. Cl. 210/703; 210/221.2; 119/259

(57) ABSTRACT

An internal marine aquarium filter that provides protein skimming, biological, mechanical and chemical filtration is disclosed. The filter creates direct adjustable current for the aquarium independent of the activities of filtration and uses a pump. The filter includes an outer casing with dedicated areas for biological, mechanical and chemical filtration, a selectively removable protein skimmer with collection cup and optional lid, a selectively removable plumbing assembly connected to the pump. An optional surface debris filtering function is also disclosed.

### CROSS-REFERENCE TO RELATED APPLICATIONS

This application is related to U.S. Pat. No. 6,869,530, issued on Mar. 22, 2005.

### BACKGROUND OF THE INVENTION

The invention relates generally to filtration and water movement for a marine aquarium. More specifically, the invention relates to an aquarium filter for removing debris and skimming protein.

For the hobbyist and researcher alike there are many devices and methods available to aid in keeping marine fish and invertebrates in the aquarium. For example, several criteria must be met for there to be a successful well-kept salt water aquarium. The water used must be natural sea water or purified water with the correct amount of proper salt mixed in. The aquarium must be kept within an adequate temperature range, it must have proper light and there must be adequate water movement, current, and filtration. The methods of filtration should include biological, chemical, mechanical and protein skimming. For a salt water aquarium to sustain life there must be a place where biological activity can take place. This is where nitrifying bacteria convert ammonia and other waste products to nitrite and then to nitrate, a less harmful compound. This process is known as the nitrogen cycle. Periodic water changes will replenish nutrients, stabilize the water and prevent a buildup of nitrate in the aquarium system.

The invention relates to filtration and the creation of direct adjustable water flow and current in the salt water aquarium. The technology, methods and devices of the prior art have associated with them specific problems and inefficiencies to which the invention is drawn.

A search of the prior art did not disclose any patents that read directly on the claims of the invention; however, for background purposes and as indicative of the art to which the invention relates, reference may be made to the following patents found in the search:

| U.S. PAT. NO. | DATE ISSUED | INVENTOR | CLASS/SUBCLASS |
|---|---|---|---|
| 5,171,438 | Dec. 15, 1992 | Korez | 210/169 |
| 5,385,665 | Jan. 31, 1995 | Neuhaus | 210/169 |
| 5,518,611 | May 21, 1996 | Bresolin | 210/169 |
| 5,832,870 | Nov. 10, 1998 | Lin | 119/261 |
| 5,901663 | May 11, 1999 | Reinke | 119/259 |
| 6,303,028 | Oct. 16, 2001 | Marks et al. | 210/169 |
| 6,659,043 | Dec. 9, 2003 | Huska | 119/226 |
| 6,732,675 | May 11, 2004 | Liao | 119/259 |

The common basic devices of the prior art used for filtering and creating a direct adjustable water flow and current in the salt water aquarium consist of a canister filter, basic filter the wet-dry or sump system, a protein skimmer and the use of individual submersible or external pumps. Canister and basic filters operate in or out of the aquarium. They receive water from the aquarium, pass it through filter media and then send the filtered water back to the aquarium. Wet-dry or sump filters receive water from the aquarium, filter it biologically, chemically, mechanically or by way of protein skimming and then return the filtered water back to the aquarium. A protein skimmer is a unit requiring a means to mix water and air in a chamber and a means to allow the waste extracted to exit the aquarium system. It can function in or out of the aquarium or sit inside or outside of a wet-dry or sump filter. Individual submersible or external pumps are used to create direct adjustable water flow or currents inside the aquarium.

In the design and function of the canister or basic filter, there are problems and inefficiencies. The performance of these filters is limited to only basic biological, mechanical and chemical filtration. These filters only draw water in from below the surface level, leaving floating waste and debris to accumulate on the surface of the water of the aquarium. Whether they function in or out of the aquarium the waste accumulated in the filter could foul the water of the system before it is removed. The water passing through the filter and returning to the tank is not independent of the function of filtration; therefore, it is not a direct dedicated source of current for the aquarium. As waste and debris accumulate in the filter, the flow of water back to the aquarium could slow down and put additional stress on the pump and the aquatic system. Furthermore, for the simple nature of their function the units and their parts are complicated to manufacture.

The use of the wet-dry or sump system is a common method used to filter salt water aquariums. Upon examination, the problems and inefficiencies associated with this system become apparent. Wet-dry or sump systems require that the aquarium be drilled and a pre-filter installed or they require the use of an overflow box that relies on a siphon to remove the water from the aquarium if they are to function outside of the aquarium. These required conditions are complicated, expensive to create and add many points of failure to the system. If a wet-dry is to function inside of the aquarium utilizing a trickle method of filtration, evaporation becomes a problem due to the limited space and the requirement to maintain different levels of water accurate in the system. Due to the fact that wet-dry or sump systems perform their functions with their modes of filtration operating adjacent to one another, within an outer casing, the overall size of the unit becomes a disadvantage and these units end up positioned below the aquarium or become obtrusive inside the aquarium.

A wet-dry or sump system requires three pumps to perform filtration, provide protein skimming and create a direct, independent, dedicated current inside the aquarium. External wet-dry or sump systems that use a trickle method of filtration add additional surface area to the aquarium system which results in excessive evaporation. When a wet dry or sump system utilizes a protein skimmer, the water drawn into the skimmer has already been passed through some previous method of filtration. This event drastically reduces the efficiency of the skimming effect. In addition, a wet-dry or sump system creates excessive, unwanted noise and (based upon the extent of its functions and structural requirements relative to its size and the amount of water that it must hold) it can be complicated and expensive to manufacture.

The protein skimmer of the prior art is a unit with a means to create a mixture of air and water. This form of filtration is known as foam fractionation. Some of the problems and inefficiencies associated with the protein skimmer are that it performs only one function requires its own pump and (because of the nature of its function) is complicated to manufacture. In addition, if it functions outside of the aquarium it becomes a point of failure for leakage. If it functions within the aquarium it only draws water in from below the surface, leaving organic wastes to accumulate on the surface of the aquarium water. While in the aquarium, the protein skimmer takes away from the aesthetic nature of the marine environment. Some models function inside or outside of the wet-dry or sump system. The problem however, is that the water that is drawn into the skimmer has already been filtered through the wet-dry or sump. This event drastically reduces the efficiency of the skimming effect. The most efficient protein skimmer will draw in raw unfiltered water from the surface and below the surface of the aquarium, giving it the chance to remove organic waste and push it out of the system before it gets trapped in other filter media to remain in the system. Furthermore, a stand-alone unit outside of the wet-dry or sump requires additional plumbing for installation and is a point of failure for possible leakage.

In the prior art, the individual submersible pump installed in the aquarium or a pump cooperating with a filter system are used to create current in the aquarium. These methods have with them associated problems and inefficiencies in their function. The individual submersible pump in the aquarium adds excess heat to the system, requires more power, adds extra expense, and also results in an additional point of failure. The pump is mounted inside the aquarium, is difficult to hide aesthetically, and may pose a threat to small fish and invertebrates that go near its intake.

In the prior art, when it comes to creating water current in an aquarium, a pump that cooperates with a filter system is inefficient in its function in several ways. The pumps first function is to pass water through filtration and this main event determines the size and water flow characteristics of the pump. This leaves the current creating requirement of the function dependent upon what pump is needed to make the filter work properly. A simple example of this problem is to try to get a pump that needs to flow water through filtration at 40 gallons per hour to create a current in an aquarium equivalent to 400 gallons per hour. Certain marine invertebrates require high currents irrelevant of the requirements of the rate of flow through filtration. The creation of direct water flow and current is most efficient when it is independent of the activity of filtration. Another illustration of this is during feedings. When the aquarium system has water flow and current that exceed the rate of filtration, more nutrition can be taken up by the animals and less of it ends up in the filter as a waste product. This leads to more efficient feedings, reduced cost and less bio-load added to the system.

### BRIEF SUMMARY OF THE INVENTION

In accordance with one aspect of the invention, an aquarium filter unit is provided that has direct independent water flow and current for the aquarium as well as protein skimming, and biological, mechanical, and chemical filtration all within its outer casing. The protein skimmer may be fully adjustable and operates to draws in raw unfiltered water from below the surface of the aquarium through openings in the outer casing sidewalls near the bottom of the outer casing, as well as water at the surface through an opening at the top in the front of the outer casing. All of the functions of the unit are driven by a submersible pump. Rising above the outer casing of the unit, the protein skimmer with its collection cup and lid may be easily removable for cleaning.

A plumbing assembly with pump is positioned below the protein skimmer. A removable pump is connected to the bottom of the plumbing assembly surrounded by the outer casing with biological filter sponges above and below it. The whole plumbing assembly is easily removed for cleaning and maintenance. This combination of conditions and functions among others makes the unit whisper quiet, easy to maintain, multifunctional and unobtrusive in the aquarium. The design, function and arrangement of the elements of the unit overcome all of the known limitations, problems and inefficiencies of the basic or canister filter, the wet-dry or sump system, individual submersible pump and the protein skimmer of the prior art.

With the use of this unit the aquarium water never leaves the aquarium. The unit does not require the aquarium to be drilled with pre-filters installed or use overflow boxes, siphons or drainage. Additional plumbing is not required. This eliminates many points of failure and the need for additional equipment, lowers expense and makes installation and maintenance quick and easy while providing all of the necessary filtration, protein skimming and water current requirements of the modem marine aquarium.

### BRIEF DESCRIPTION OF DRAWINGS

FIG. 1 is a general perspective view of a an aquarium filter in accordance with one embodiment of the invention.

FIG. 2 is a schematic view of the aquarium filter of FIG. 1.

FIG. 3 is an illustrative drawing of the aquarium filter of FIG. 1 installed in an aquarium.

FIG. 4 is a perspective view of an aquarium filter in accordance with another embodiment of the invention.

FIG. 5 is a perspective view of an outer casing of the aquarium filter of FIG. 4.

FIG. 6 is a schematic view of the aquarium filter of FIG. 4.

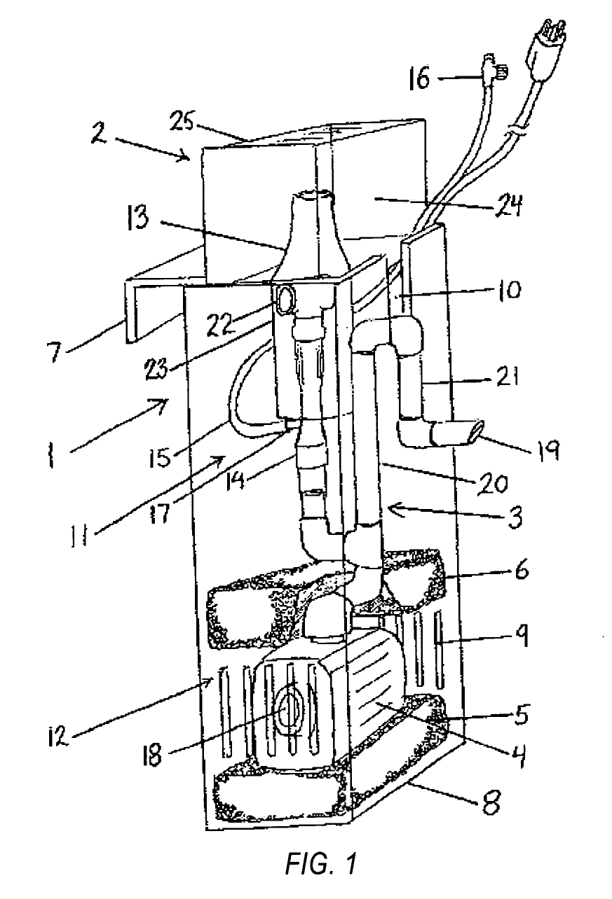

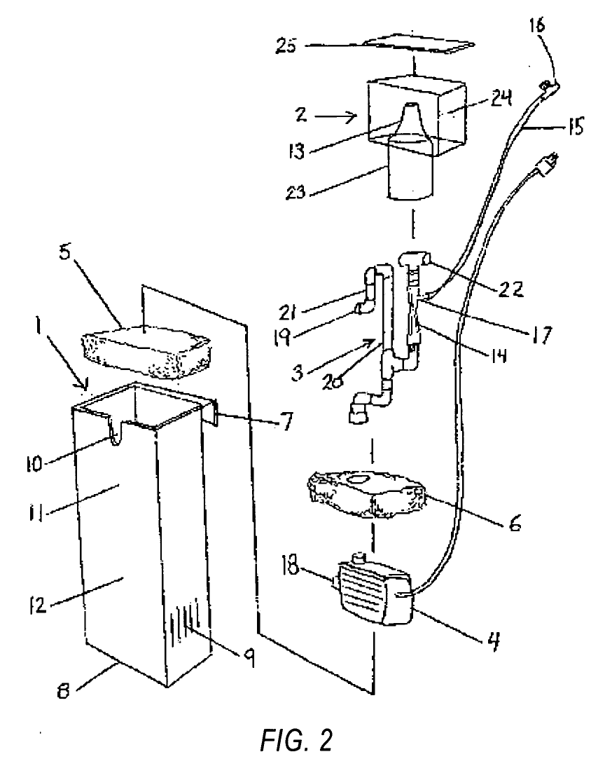

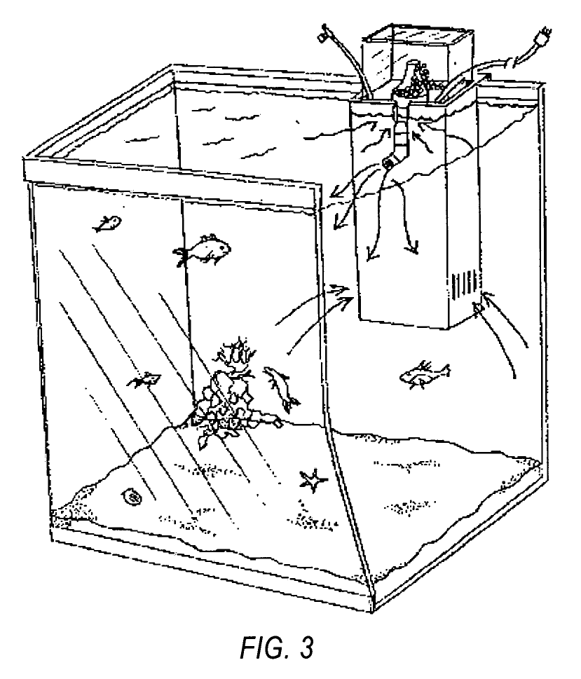

### DETAILED DESCRIPTION OF THE INVENTION

In one embodiment, the aquarium filter includes five components: an outer casing (1), a protein skimmer (2), a plumbing assembly (3) with removable pump (4), a lower sponge (5) and an upper sponge (6) which perform the functions of biological and mechanical filtration. The outer casing (1) is made of 3/8 inch thick black acrylic plastic. It is formed with four sides, a bottom and is open from the top. The outer casing has a rear hanger (7) which enables it to hang on the inside of any of the four walls of an aquarium. It has a substantially flat bottom (8) allowing it to be positioned upright anywhere inside on the bottom of an aquarium. The outer casing has a plurality of openings towards the bottom of both sides (9). This plurality of openings allows water below the surface of the aquarium to enter the outer casing. On the front panel of the outer casing there is an opening at the top center (10) which allows water at the surface to enter and is where the plumbing assembly is suspended inside the outer casing. Two internal areas of the outer casing are indicated as an upper area above the first sponge (11) and a lower area below the first sponge (12).

The protein skimmer is preferably fabricated from clear acrylic plastic, and more specifically 3/16 inch acrylic sheet and acrylic tube. The upper riser (13) may be formed by heating and flaring one end to form a funnel. The parts are then secured together with acrylic cement to form a water tight bond.

The plumbing assembly with removable pump is comprised of PVC parts and is preferably ½ inch in diameter, an injector (14), a piece of hose (15), a small plastic air valve (16) and a removable submersible pump. The injector is a device which creates a vacuum of air that is pulled through the injector barb (17) as pressurized water passes through it. The hose is attached to the barb and the small plastic air valve is attached to the other end. The valve controls how much air is allowed into the injector, resulting in full control of the amount of waste removed from the protein skimmer. The pump is of a submersible type. The only requirements for the pump is that it fits in the lower space of the outer casing, can be connected to the plumbing assembly and its flow rate meets the flow requirement of the desired application.

The two sponges providing a place for biological activity are firm and porous filter sponges of the same type. The upper sponge is positioned between the protein skimmer and the pump. The lower sponge is positioned at the bottom of the outer casing.

Upon placement of the unit in a full aquarium, water will enter the outer casing through the plurality of openings in the outer casing. The water will rise inside the outer casing until the height of the water level in the outer casing is equal to the height of the water outside the outer casing in the aquarium. At this point, the plumbing assembly and pump, the two sponges and the lower chamber of the protein skimmer will be submerged within the outer casing.

Once the pump is activated, water will be drawn into the intake of the pump (18) and sent through the plumbing assembly. The water will be drawn in from the plurality of openings at the top in the front and near the bottom on the sides of the outer casing. As the pump pushes water through the plumbing assembly, the water travels out the main shaft return (19) out to the aquarium to create water movement and current and out through the injector into the lower chamber of the protein skimmer to perform protein skimming. Since the internal opening inside the injector is smaller in diameter than the inside of the rest of the plumbing assembly, back pressure is created that sends a larger volume of water back to the aquarium to create water flow and current independent of the action of the protein skimmer. This diversion of water from one pump to perform the separate and distinct functions of foam fractionation or protein skimming, the creation of independent direct water flow and current inside the aquarium, other modes of filtration and separate, different, flows of water and current of varying and adjustable pressures, speeds and volumes for the aquarium has not been achieved in the prior art.

The exiting water of the main shaft (20) is adjustable by rotating the main shaft return or turning the down shaft (21) right to left. This gives the user the ability to adjust or change the direction of the direct water flow and current inside the aquarium.

The water that is pumped through the injector pulls a vacuum of air through the injector barb and hose. The volume of air entering is controlled by the plastic air valve. When this jet of water and air mix, it travels out the top of the injector and hits the top of the injector tee (22) and then exits both sides of the tee and hits the inside wall of the lower chamber of the protein skimmer (23). This effect creates fine air bubbles violently mixed with salt water and the result is foam fractionation.

Organic waste is attracted to the surface area of the fine air bubbles contained within the lower chamber of the protein skimmer. As constant water is jetted out the injector tee, the aquarium water loses its organic waste to the surface area of all the bubbles. The bubbles become dark with waste and get pushed up the lower chamber of the protein skimmer and then up the upper riser and finally over into the collection chamber (24). The amount of skimmer overflow is controlled by the air valve and it will collect into the collection chamber under a removable lid (25) until removed. If the overflow of skimmer waste fills the overflow chamber to capacity, additional waste overflow will spill back into the lower chamber of the protein skimmer without spilling outside the aquarium system. As water exiting the injector loses its organic waste, the cleaner water remaining flows out of the bottom of the lower chamber of the protein skimmer where it enters a space interior of the outer casing and exterior to the lower chamber where it can be further filtered biologically, mechanically or chemically by the use of certain filter media installed in this inner space.

Previously in the art, the arrangement, method and function of protein skimming, creating direct adjustable water movement or current in the aquarium independent of the protein skimmer, biological, mechanical and chemical filtration have been accomplished by using separate devices. Protein skimmers have been used inside the aquarium but do not create a direct adjustable water current independent of the water that flows out of the skimmer back into the aquarium. Water that flows out of a skimmer (the spill-out) is saturated with fine air bubbles. In addition, if the skimmer spill out were to be directed into the aquarium to effect a water current it would fill the aquarium with very fine air bubbles. If the bubbles were diverted or buffered, it would minimize the direct current. Therefore, the purpose of skimmer spill-out is not to create direct adjustable water flow or current for the aquarium but simply to allow the skimmer to function

Other filter systems will send water back to the aquarium to create current after it passes through filtration. Given this limitation they cannot create water flow or current independent of the requirements of filtration.

This invention diverts the water from a single pump to create separate and different flows of water and current, of varying adjustable pressures, speeds and volumes, into the aquarium to perform the distinct function of providing direct adjustable water flow and current to the aquarium, and through an injector into the protein skimmer to perform the function of protein skimming, and then into an inner space where it is further filtered biologically, mechanically and chemically. The functions are separate and independent of one another and yet are accomplished by the use of one pump. The water sent back to the aquarium is independent of the water sent through the injector and into the lower chamber of the protein skimmer, where it is sent through filtration.

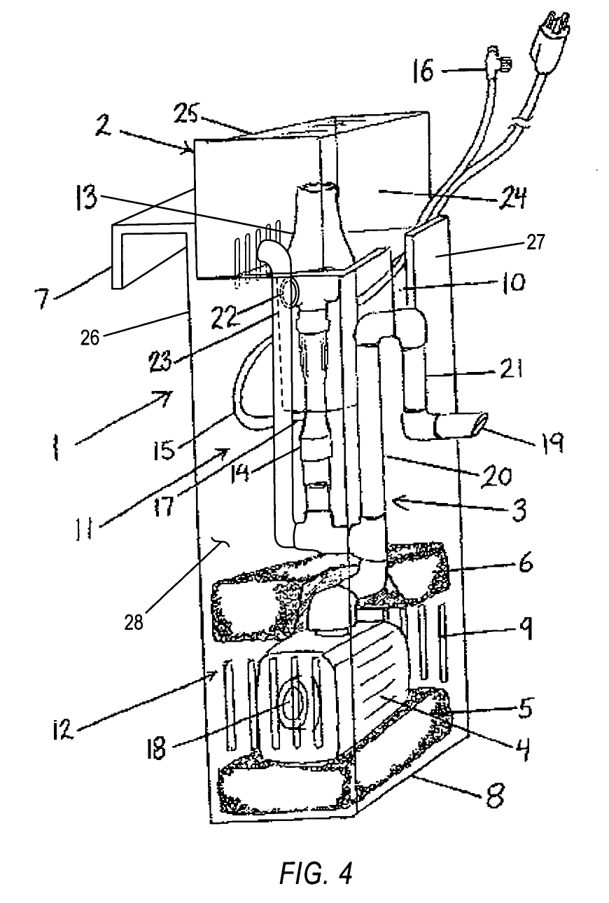

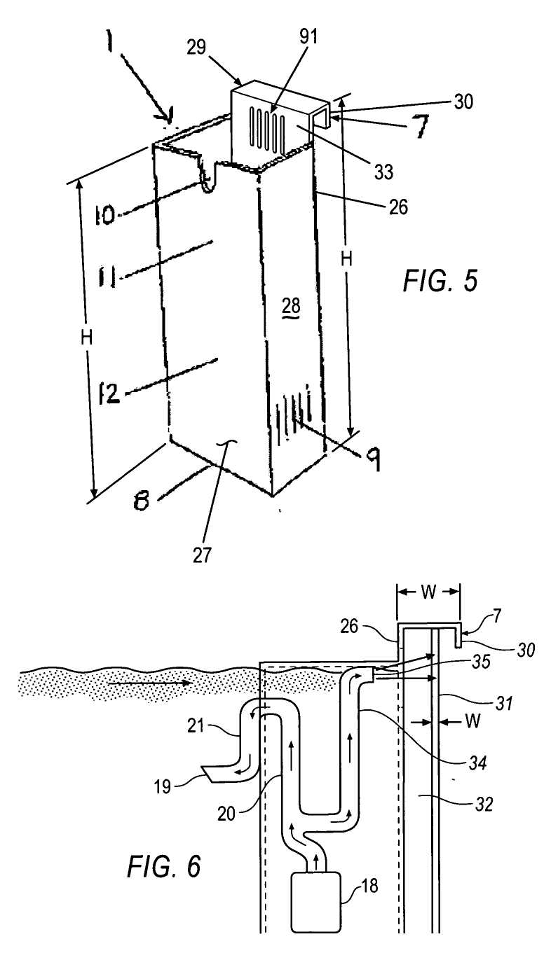

FIGS. 4-6 illustrate an alternative embodiment of a filtering system that includes a surface debris skimming feature. In accordance with this aspect of the invention, a rearward wall (26) of outer casing (1) has a height H that is slightly higher than a height h than either a forward wall (27) or opposing sidewalls (28).

A top portion (29) of rearward wall (26) is attached to rear hanger (7). In one embodiment, rear hanger (7) is integrally attached to rearward wall (26). Rear hanger (7) includes a downwardly extending lip (30) that cooperates with rearward wall (26) to define a width (W) of rear hanger (7). Width (W) of rear hanger (7) is slightly wider than a width (w) of an aquarium tank wall (31) such that when lip (30) is positioned over aquarium tank wall (31), a slight gap passageway (32) is formed between rearward wall (26) and aquarium tank wall (31).

Rearward wall (26) further includes one or more filtering openings (9′) that are formed so as to extend through rearward wall (26). Filtering openings (9′) are positioned on an upper portion (33) of rearward wall (26) such that at least part of filtering openings (9′) are positioned above the water level of the aquarium tank.

Plumbing assembly (3) includes two returns that are operatively connected to pump (18). First return (19) extends over opening 10 and back into the aquarium, as described above. A second return (34) is positioned so as to have its outlet (35) positioned directly in front of filtering openings (9′) such that filtered water travels out through passageway (32) around outer casing (1).

In operation, water from the aquarium tank enters into outer casing (1) through opening 10 located on forward wall (27), as well as through openings (9) on the lower portion (12) of outer casing (1). Debris that collects on the top surface of the water will also flow into outer casing (1) through opening 10. The walls (26, 27, and 28) of outer casing (1) cooperate to trap water surface debris within outer casing (1). Further, first and second returns (19, 34) insure that clean and filtered water is transmitted back to the aquarium. Indeed, second return 34 actually limits surface debris from traveling back into outer casing (1) due to its position directly in front of filtering openings (9′).

While the preceding descriptions are directed to a preferred embodiment of the invention, and the invention has been described in complete detail and illustrated in the drawings, it is not to be limited to such embodiment and details since many changes and modifications may be effected without departing from the spirit and scope thereof The invention is described to cover any and all modifications, forms and arrangements which may come within the language and scope of the appended claims.

I claim:

1. A unitary filtration system for an aquarium comprising:
a protein skimmer;
a water pump;
a plumbing assembly including piping that operatively coupled said pump and said protein skimmer, said plumbing assembly adapted to allow the flow of water and air into said protein skimmer and to return filtered water to said aquarium; and
an outer casing substantially enclosing said protein skimmer, said pump, and said plumbing assembly, said outer casing having at least one opening for receiving water from the aquarium to be filtered.

2. A system according to claim 1, further comprising a skimmer collection chamber connected to said outer casing and in communication with said protein skimmer.

3. A system according to claim 1, wherein said protein skimmer has a first open end and a second open end, said first open end defining a first periphery and said second open end defining a second periphery, wherein said second periphery is smaller than said first periphery.

4. A system according to claim 1, wherein said plumbing assembly further includes at least one main shaft return that is adapted to direct a flow of water exiting from the filtration system and return to the aquarium.

5. A system according to claim 4, wherein said at least one main shaft return is selectively rotatable to change the direction of water flow being returned to the aquarium.

6. A system according to claim 1, wherein said piping of said plumbing assembly includes an injector tube having a reduced diameter portion therein for creating a back pressure and a vacuum of air within said plumbing assembly.

7. A system according to claim 1, wherein said pluming assembly further includes a barb member that is connected to a portion of said piping, said barb being hollow and being in communication with an interior of said piping, said barb receiving one end of an air supply tube thereon.

8. A system according to claim 1, wherein said plumbing assembly further includes a piping element for directing water and air into said protein skimmer, said piping element having at least one opening that is positioned within said protein skimmer.

9. A system according to claim 8, wherein said piping element includes at least two openings, each of said openings facing an interior wall of said protein skimmer.

10. A system according to claim 1, wherein said outer casing includes at least one opening positioned adjacent to said pump, wherein water is drawn into said outer casing and into said pump.

11. A system according to claim 1, wherein said outer casing further includes at least one opening positioned adjacent a top portion of said outer casing such that water from a top surface of the aquarium is received within said outer casing.

12. A system according to claim 1, further comprising at least one sponge adapted for biological and mechanical filtering of water within said outer casing.

13. A system according to claim 12, wherein said at least one sponge has an outer periphery that is defined by a size and shape that corresponds to the size and shape of said outer casing such that said at least one sponge is in contact with interior walls of said outer casing.

14. A system according to claim 12, further including two sponges, a first sponge positioned above said water pump and a second sponge positioned below said water pump.

15. A system according to claim 1, further including a positioning member connected to a portion of the filtration system for positioning the filtration system to the aquarium.

16. A system according to claim 1, wherein one of said walls of said outer casing includes at least one filtering opening positioned on a top portion of said outer casing such that at least a portion of said at least one filtering opening extends above water surface when installed in the aquarium permitting exit of filtered water from said outer casing.

17. A system according to claim 16, wherein plumbing assembly further includes a first main shaft return that is adapted to direct a flow of water exiting from the filtration system and return to the aquarium and a second main shaft return that is positioned so as to face said at least one filtering opening so as to direct filtered water from said outer casing along the water surface of the aquarium.

18. A system according to claim 16, wherein a rearward wall of said outer casing has a height that is longer than the height of the remaining walls of said outer casing.

19. A system according to claim 18, wherein a positioning member is connected to said rearward wall, said positioning member having a width that is longer than a width of a side wall of the aquarium.

20. A method of filtering water in an aquarium comprising the steps of:
providing a unitary filtration system that includes a plumbing assembly, a protein skimmer, and a pump, wherein an outer casing of said filtration system substantially encloses said plumbing assembly, said protein skimmer, and said pump;
simultaneously drawing unfiltered water from the aquarium into said outer casing from the surface of the water and below the surface of the water;
drawing said unfiltered water received within said outer casing through a pump intake of said pump;
diverting water drawn through said pump intake in both a first and second direction through the use of said plumbing assembly;
skimming water diverted in said first direction through the use of said protein skimmer; and
supplying a water current from water diverted in said second direction through a main shaft return that is coupled to said plumbing assembly.

21. A method according to claim 16, wherein the step of diverting water drawn through said pump intake in said first and second direction includes diverting water through a first and second path of said plumbing assembly.

22. A method according to claim 16, wherein the step of supplying said water current through said main shaft return includes selectively rotating said main shaft to adjust the flow of water.

23. A method according to claim 16, wherein said step of skimming further includes creating air bubbles and capturing organic waste within a collection chamber.

24. A method according to claim 16 further including the step of collecting surface debris of the aquarium within said outer casing.
